(19) United States
(12) Patent Application Publication
(10) Pub. No.: US 2022/0329478 A1
(43) Pub. Date: Oct. 13, 2022

(54) ADAPTIVE SPARE EQUIPMENT ALLOCATION TECHNIQUES

(71) Applicant: AT&T Intellectual Property I, L.P., Atlanta, GA (US)

(72) Inventors: Rudolph Mappus, Plano, TX (US); George Goehring, Atlanta, GA (US); Mark Morris, Midlothian, TX (US)

(21) Appl. No.: 17/226,747

(22) Filed: Apr. 9, 2021

(51) Int. Cl. H04L 12/24; H04L 12/26

(52) U.S. Cl. CPC H04L 41/0668; H04L 41/12; H04L 43/0817

(57) ABSTRACT

Architectures and techniques are presented that improve or optimize (e.g., within a factor of optimal) spare equipment allocation. Efficient spare equipment allocation is capable of satisfying many orthogonal or even conflicting goals such as reducing the cost of purchase and storage of the spare equipment while simultaneously seeking to reduce downtime due to failed equipment resulting from too sparse coverage by the spare equipment. A sparing procedure can identify depot nodes that are indicative of depot locations where a spare device is to be stored.

### TECHNICAL FIELD

The present application relates generally to adaptive techniques for determining spare equipment allocation, e.g., adapting spare equipment allocation based on constraints or based on characteristics of locations where the equipment is in-use.

### BACKGROUND

Equipment used to provide network services can fail, which can lead to downtime for the service being provided while the failed or faulty equipment is replaced. In order to limit this downtime, spare equipment is often maintained at or near locations where the equipment is in use.

### BRIEF DESCRIPTION OF THE DRAWINGS

Numerous aspects, embodiments, objects and advantages of the present application will be apparent upon consideration of the following detailed description, taken in conjunction with the accompanying drawings, in which like reference characters refer to like parts throughout, and in which:

FIG. 1 depicts a block diagram of an example system 100 that can perform a sparing procedure that can identify an allocation applicable to spare equipment comprising a spare device in accordance with certain embodiments of this disclosure;

FIG. 2A shows illustration 200A depicting an example orthogonal view of the group of locations in accordance with certain embodiments of this disclosure;

FIG. 2B shows illustration 200B depicting an example of the graph that might be generated from data associated with the group of locations in accordance with certain embodiments of this disclosure;

FIG. 3 illustrates a block diagram of an example system 300 that can provide for additional aspects or elements with determining the supply distance in accordance with certain embodiments of this disclosure;

FIG. 4 illustrates a block diagram of an example system 400 that depicts techniques relating to adaptively choosing a type of the sparing procedure to utilize in accordance with certain embodiments of this disclosure;

FIG. 5 shows illustration 500 that depict various examples of data that can be relied upon to select a particular type of the sparing procedure in accordance with certain embodiments of this disclosure;

FIG. 6 illustrates an example method that can perform a sparing procedure that can identify an allocation applicable to spare equipment comprising a spare device in accordance with certain embodiments of this disclosure;

FIG. 7 illustrates an example method that can provide for additional elements or aspects in connection with the sparing procedure that can identify an allocation applicable to spare equipment comprising a spare device in accordance with certain embodiments of this disclosure;

FIG. 8 illustrates a first example of a wireless communications environment with associated components that can be operable to execute certain embodiments of this disclosure;

FIG. 9 illustrates a second example of a wireless communications environment with associated components that can be operable to execute certain embodiments of this disclosure; and

FIG. 10 illustrates an example block diagram of a computer operable to execute certain embodiments of this disclosure.

### DETAILED DESCRIPTION

### Overview

Operations teams of network service providers typically manage a large inventory of solid-state equipment such as routers, multiplexers, switches, hubs, and so on. These equipment represent different technologies and handle different transmission mediums and types to provide network services. These equipment carry and route customer data, so, upon failure, customer services may be negatively affected.

For equipment that is deemed critical to providing services, operations teams may maintain an on-hand set of spare equipment that is used to rapidly restore services when in-use equipment fails. Spare inventory can be kept to prevent significant downtime. In some cases, spares can be housed in centralized supply chain centers. Naively, operations teams can maintain spare inventory for each device that is in-use, either on-site or at the central supply chain centers. Such a strategy, while potentially effective at reducing downtime, is also expensive and inefficient considering these spare equipment have costs to acquire and store. In the case of certain devices, availability might also be quite limited.

In contrast to commodity-type equipment used by network service providers, solid-state equipment has a very low failure rate that is below a threshold for conventional spare allocation schemes to be effective. Furthermore, network evolution has relegated much solid-state equipment to legacy equipment that is no longer manufactured at scale, which represents a concern for spare inventory management. Certain types of equipment have scarce availability and it can be challenging to merely find a vendor for some legacy resources. Significant downtime can result from a lack of availability of a particular device on an open market. Hence, a sparing strategy that minimizes the risk of downtime while simultaneously minimizing spend or requests for difficult-to-acquire spare devices can be a welcome advance.

Further, decentralized supply chain strategies can create opportunities for space management. Fewer items in centralized distribution centers can allow for more productive space management strategies. Together, these issues demand new solutions for optimizing spare inventory levels and storage locations so that time to repair constraints (e.g., based on service line agreements with customers, regulatory requirements, and so forth) can be met or minimized, while reducing or potentially minimizing spare inventory levels.

In mathematics literature, set cover problems and bin packing problems are well known. It has been shown that a general solution to the set cover problem or the bin packing problem requires a nondeterministic Turing machine to solve in polynomial time. Hence, a general solution that can be determined in polynomial time is deemed impossible.

In a similar way, a general solution to a spare allocation problem can be shown to require a nondeterministic Turing machine to solve in polynomial time. In fact, the sparing solutions can be framed similar to the bin packing problem, where spares are bins and a goal is to assign as many in-use equipment to that spare and to locate that spare as closely as possible to the in-use equipment. It is known that bin packing problems are similar to set cover problems. In fact, the two problem formulations are related.

In order to frame a spare allocation optimization problem in the context of a set cover problem, the following can be assumed. Given a superset of locations and a set of subsets of the superset, one aim can be to find a minimal cost set of subsets that ‘cover’ or contain all locations of the superset. In spares optimization, subsets are the locations where one element contains a spare, and the remaining subset elements depend on that spare (e.g., they are locations where the equipment is in service and depend on the spare that is reasonably proximate to sufficiently limit time to repair). In these equipment, the most significant factor in time to repair is the time required to fetch the spare. If the spare is at the location, fetch time is 0. If the spare is elsewhere, fetch time is the driving time to retrieve the equipment.

In order to frame a spare allocation optimization problem in the context of a bin packing problem, the following can be assumed. In bin packing, one can assign as many elements to as minimal a number of bins. In spares optimization, the spare equipment can be a bin and the locations that depend on that spare can be the elements to assign to a bin.

In both set cover approaches and bin packing approaches applied in the context of spare allocation optimization, it can be shown that general solutions to these problems require a nondeterministic Turing machine to solve in polynomial time. By posing the spares set cover problem as a linear programming problem, it can be shown that set cover problems are dualities of bin packing problems in optimization, and that solutions can be found within a factor of optimal. The disclosed subject matter is discussed in the context of solutions to spare equipment allocation. But it is noted that being able to solve spare allocation optimization in polynomial time with a deterministic Turing machine means that a similar approach in connection with the disclosed techniques can be used to similarly solve set cover problems and bin packing problems, which is considered by conventional literature to be impossible.

### Example Systems

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

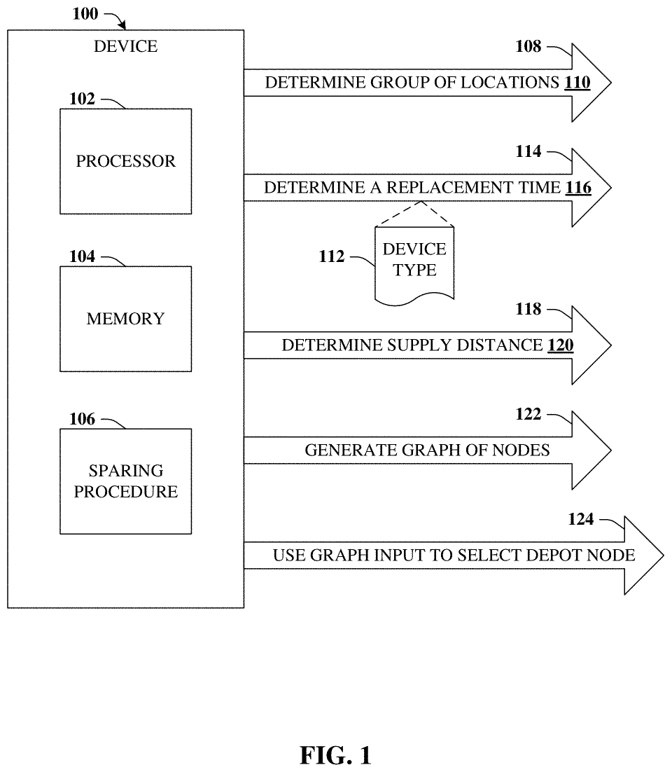

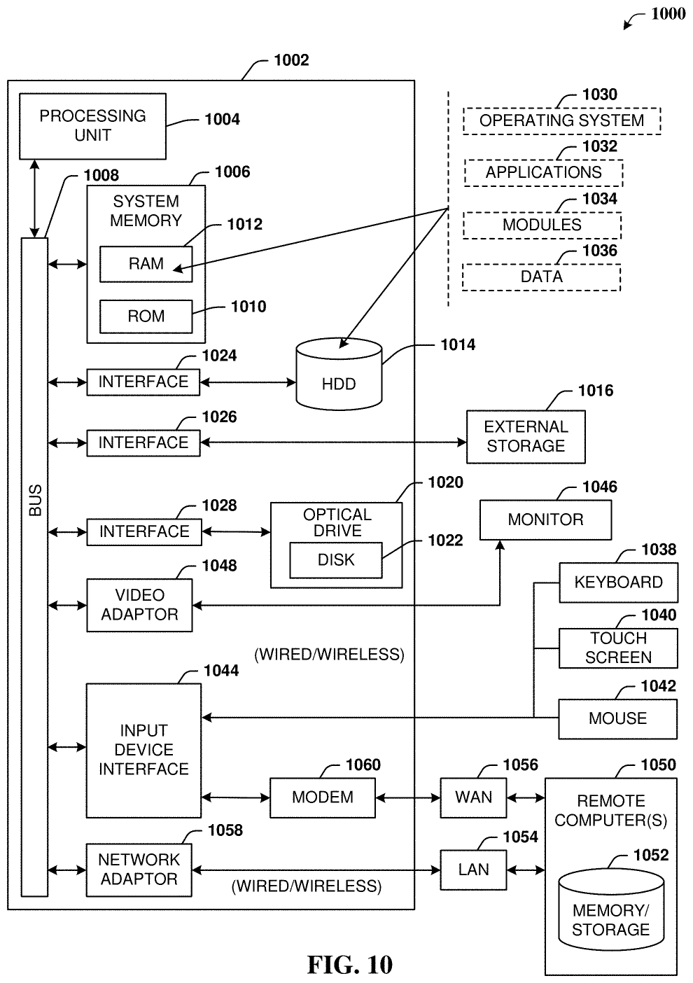

Referring now to FIG. 1, device 100 is depicted. Device 100 can perform a sparing procedure that can identify an allocation applicable to spare equipment comprising a spare device in accordance with certain embodiments of this disclosure. Device 100 can comprise a processor 102 that can be specifically configured to perform sparing procedure 106 and a memory 104 that stores executable instructions that, when executed by the processor, facilitate performance of operations. Device 100 can comprise sparing procedure 106 component or circuit that can be specifically tailored to perform spare equipment allocation operations. Processor 102 can be a hardware processor having structural elements known to exist in connection with processing units or circuits, with various operations of processor 102 being represented by functional elements shown in the drawings herein that can require special-purpose instructions, for example stored in memory 104 and/or sparing procedure 106 component or circuit. Along with these special-purpose instructions, processor 102 and/or device 100 can be a special-purpose device. Further examples of the memory 104 and processor 102 can be found with reference to FIG. 10. It is to be appreciated that device 100 or computer 1002 can represent a server device of a communications network or a user equipment device and can be used in connection with implementing one or more of the systems, devices, or components shown and described in connection with FIG. 1 and other figures disclosed herein.

In response to execution of the executable instructions stored to memory 104, Device 100 can determine group of locations 110, which is illustrated by determination 108. Group of locations 110 can comprise locations where a device is operable to provide a service. In addition, group of locations 110 can comprise warehouse locations that are suitable to store the spare device. It is appreciated that the type of the device (e.g., device type 112) and a type of the spare device can be equivalent. Hence, the spare device is suitable to replace the device in the event the device fails or otherwise is to be replaced. It is appreciated that the disclosed sparing strategies can be applied independently for different equipment/devices having a different device type 112. Likewise, different device types 112 can have different characteristics that can be integral to the spare allocation strategies detailed herein such as, for example, different failure rate profiles, different replacement time values, and so forth.

As a function of device type 112, determine a replacement time 116, which is illustrated by determination 114. Replacement time 116 can be representative of a time allotted and/or allowed to replace the device with the spare device. Such can be based on contractual agreements, regulatory requirements, or internal guidelines that indicate a maximum amount of downtime for the device of the device type 112. In some embodiments, replacement time 116 can include a fetch time and/or drive time to bring the spare device to the location of the failed or faulty device to be replaced. In some embodiments, replacement time 116 can include an install time that can indicate an expected amount of time remove the device and install the spare device. Thus, e.g., subtracting the install time from replacement time 116 can yield a fetch time, which can be used to determine supply distance 120, which is illustrated by determination 118.

At determination 118, device 100 can determine supply distance 120. Supply distance 120 can be representative of a maximum distance between the device and the spare device. As noted above, such can be determined based on replacement time 116. Device 100 can further generate a graph, as illustrated by reference numeral 122. This graph can comprise a group of nodes that represent the group of locations 110 that were determined in connection with determination 108.

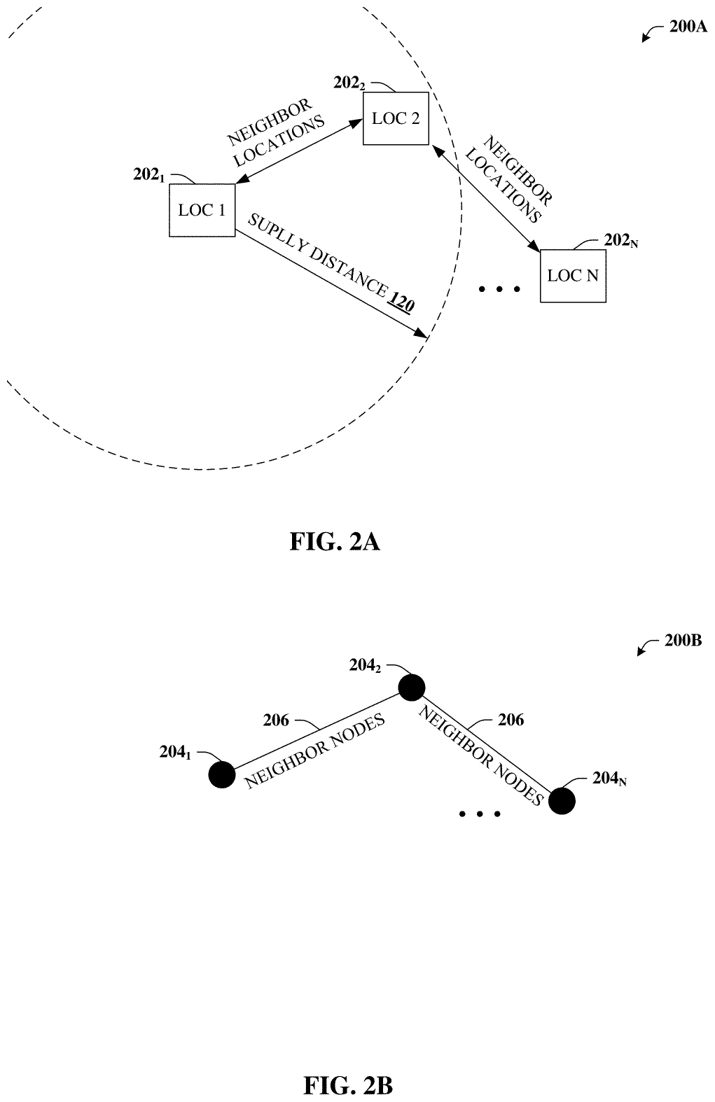

While still referring to FIG. 1, but turning as well to FIGS. 2A and 2B, illustrations 200A and 200B are depicted. Illustration 200A depicts an example orthogonal view of group of locations 110 in accordance with certain embodiments of this disclosure. In this example, group of locations 110 is represented by N different locations 202₁-202_{N}, where N can be any natural number. Using location 202₁ as a reference point, an example supply distance 120 is plotted, and any other location that is within the radius of supply distance 120 can be determined to be a neighbor location. Thus, in this example, location 202₂ is a neighbor location, whereas location 202_{N} is not a neighbor location. However, location 202_{N} is a neighbor location to location 202₂ based on the supply distance 120.

Illustration 200B depicts an example of the graph that might be generated from data associated with group of locations 110 in accordance with certain embodiments of this disclosure. Nodes 204₁-204_{N} can represent locations 202₁-202_{N}. Nodes 204₁ and 204₂ can be connected by an edge 206, and thus considered neighbor nodes, in response to a determination that locations 202₁ and 202₂ are neighbor locations, that is, separated by a physical distance that is no more than supply distance 120. In some embodiments, an edge length or weight can represent the physical distance and in that case a maximum edge length or weight can be limited by supply distance 120.

Still referring FIG. 1, using the graph as input, device 100 can perform sparing procedure 106, which is illustrated at reference numeral 124. sparing procedure 106 can select a depot node indicating a depot location from among the group of locations that is to store the spare device. For example, if node 204₂ of the graph is selected as a depot node, such can indicate that location 202₂ is identified as the depot location where the spare device is to be stored.

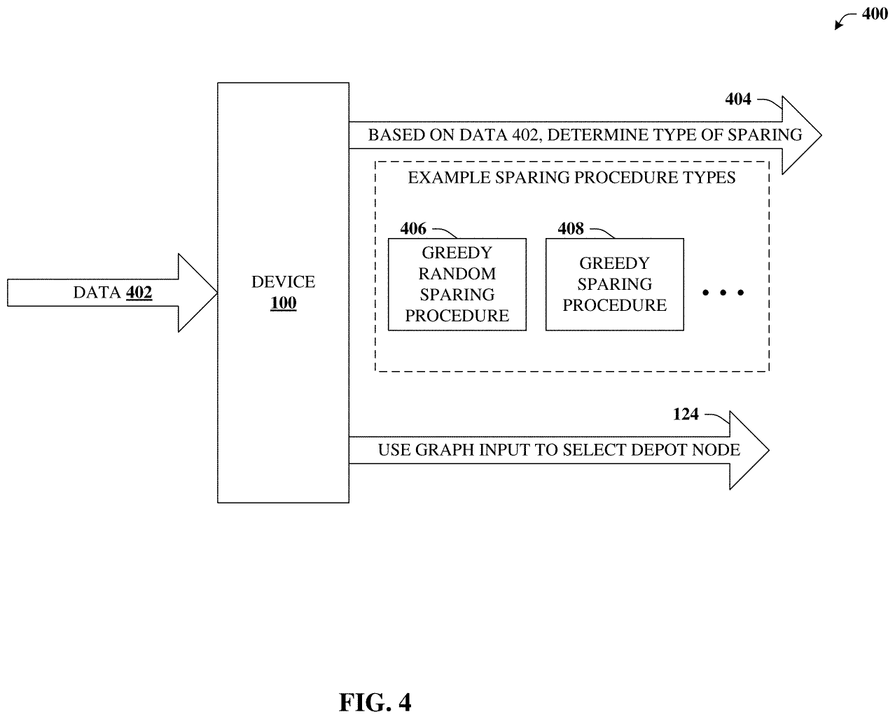

It is appreciated that while the graph supports edges 206, the initial graph input to sparing procedure 106 might only include the group of locations 110 or might include a partial set of edges 206. All or a portion of edges 206 can be added subsequently during operation of sparing procedure 106, which may differ based on the type of sparing procedure 106 that is used, which is further detailed in connection with FIG. 4. In any case, edges 206 can be applied as a function of supply distance 120, which in turn can be a function of replacement time 116.

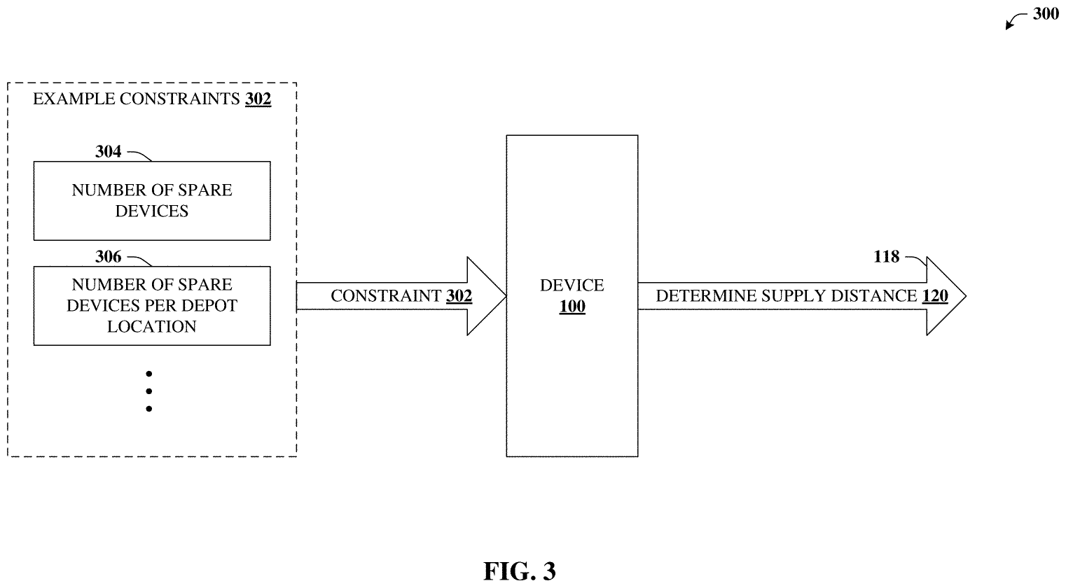

With reference now to FIG. 3, system 300 is depicted. System 300 can provide for additional aspects or elements with determining the supply distance 120 in accordance with certain embodiments of this disclosure. For example, determination 118 that determines supply distance 120 can be subject to constraint 302. In other words, a value or length or size of supply distance 120 can be affected or adjusted by constraint 302. For instance, in some embodiments, constraint 302 can reflect a limit on a number of spare device that is included in the spare equipment, which is illustrated at reference numeral 304. As another example, constraint 302 can reflect a limit on a number of spare devices per depot location, which is illustrated at reference numeral 306. It is appreciated that other example constraints 302 can exist and that any such constraint 302 can be applied in combination with other constraints. For example, if the number of spare devices per depot location is constrained to one and the number of spare devices (in total) is constrained to twenty, then sparing procedure 106 can identify, at most, twenty different depot nodes from among the group of locations 110. Under those constraints, supply distance 120 can be varied accordingly.

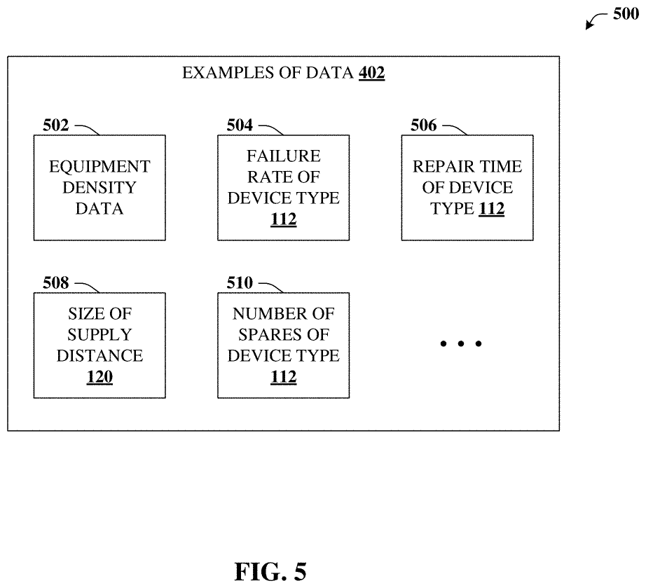

Because supply distance 120 can directly impact the arrangement of edges 206 on the graph, spare allocation optimization (e.g., within a factor of optimal) under these constraints 302 can be significant. However, the ability to allow for and to configure these and other constraints 302 can have value to supply chain management as these constraints can reflect supply realities relating to budgeting mandates, equipment scarcity on the open market, and so on. Hence, the adaptive nature of sparing procedure 106 can adapt to real world constraints and further adapt to inherent characteristics of the group of locations 110, which is further detailed in connection with FIGS. 4 and 5.

Turning now to FIG. 4, system 400 is illustrated. System 400 depicts techniques relating to adaptively choosing a type of sparing procedure 106 to utilize in accordance with certain embodiments of this disclosure. In some embodiments, they type of sparing procedure 106 selected can be based on data 402, which is illustrated at reference numeral 404. Data 402 can be representative of certain characteristics of group of locations 110 and/.or characteristics of the equipment located at group of locations 110 or services provided by that equipment. Various examples of data 402 are illustrated in connection with FIG. 5.

By way of example, the sparing procedure types can be greedy random sparing procedure 406, greedy sparing procedure 408, or another suitable procedure. Based on the type of sparing procedure 106 that is selected, different results or solutions can be obtained (e.g., different depot node selection). Moreover, different sparing procedure types can have different advantages, or, potentially even disadvantages, that can be leveraged to select a preferred or sparing procedure 106.

To that end, in analyzing the sparing goals of a large service provider several observations can be made. For example, equipment usage in the network can vary significantly. The distribution of in-use locations can depend on the equipment type, generally due to the technology used and/or service being provided to customers. Another observation is that there are some equipment locations that are spatially isolated. That is, these ‘island’ locations are too far (e.g., greater than a defined island distance threshold) from any other utilization location to be able to benefit from sharing a common spare device. To improve the efficacy of sparing procedure 106, these island locations can be removed from consideration. Ideally, the number of island locations will be small, but in any case the handling of island locations can be determined independently. For example, the decision to keep spare equipment at those locations can be based on the maximum time to repair metrics for that equipment at that location. If the maximum time to repair is less than the time to fetch the equipment from a depot location, then the spare can be stored at the location.

Hence, the group of locations 110 can exclude any identified island locations, meaning the graph generated at reference numeral 122 will not include nodes representative of those island locations. For instance, the initial graph input to sparing procedure 106 can include nodes representative of a list of candidate locations that are capable of storing spare equipment or a specific spare device. As noted, such can be in-use locations as well as warehouse locations. A second parameter received by sparing procedure 106 can be the radius of a location to be considered as an island location (e.g., the defined island distance threshold). It is appreciated that in application of sparing procedure 106, certain distances or thresholds relied on can vary between equipment types.

In some embodiments, sparing procedure 106 can perform clustering and decomposing operations of the graph. For example, after removing island locations and combining other in-use locations with other candidate locations (e.g., warehouse locations), sparing procedure 106 can operate to determine optimal (e.g., within a factor) spare device allocation that simultaneously reduces or minimizes downtime while using a fewest number of spares to cover those locations. Depending on the cardinality of the set of remaining in-use locations, the proposed techniques can group candidate locations for optimization.

For example, consider the graph of candidate and in-use locations (e.g., generated based on group of locations 110) where edge weights represent distances. Sparing procedure 106 can generate clusters using, for example, a minimum k-cut technique or another suitable technique that appropriately cuts the graph into different clusters. In some embodiments, the k parameter of the minimum k-cut technique can be set through binary search over k by ensuring max cluster size. The max cluster size can be the upper limit of the number of locations among group of locations 110 that can be evaluated using the optimization technique.

After said clustering and decomposing techniques, the specific type of procedure or solution can be selected, e.g., selected from among a greedy random solution, a greedy solution, or another suitable solution, as illustrated at reference numeral 404. The selected solution can then be applied for determining efficient or optimal depot nodes (e.g., that indicate the associated depot location where a spare device is to be stored) within each cluster generated by the minimum k-cut technique. It is appreciated that there is an intuition that by randomly selecting locations from the uncovered set of locations, the solution will rapidly generate results.

In the case of selection of the greedy random solution, the following process can be performed. Input to sparing procedure 106 (e.g., in this case a greedy random procedure) can be an unweighted location graph representative of a union of in-use locations and approved storage candidates and excluding island locations. Output of sparing procedure 106 in this case can be a list of depot nodes. In order to generate these results, the input can be received and the following operations can be iteratively or recursively performed until all nodes are ‘covered’ by a spare, which can be programmatically implemented as a while loop or another type of loop:

(1a) Randomly select a node from among all the ‘uncovered’ nodes.

(2a) Collect selected node and immediate node neighbors that are connected to the selected node by an edge.

(3a) From among the selected node and immediate neighbors, rank nodes by connectivity (e.g., the number of edges whose nodes are uncovered).

(4a) Assign highest ranking node (e.g., having the most neighbors connected by an edge) as a depot node.

(5a) Remove selected node and neighbor nodes from the uncovered location set. (e.g., from group of locations 110).

In the case of selection of the greedy solution, the following process can be performed. Input to sparing procedure 106 (e.g., in this case a greedy procedure) can be an unweighted location graph representative of a union of in-use locations and approved storage candidates and excluding island locations. Output of sparing procedure 106 in this case can be a list of depot nodes. In order to generate these results, the input can be received and the following operations can be iteratively or recursively performed until all nodes are ‘covered’ by a spare, which can be programmatically implemented as a while loop or another type of loop:

(1b) identify boundary nodes indicative of nodes within a defined number of hops from a boundary of the graph.

(2b) Rank all boundary nodes according to connectivity (e.g., the number of connected edges).

(3b) Assign highest ranking node as a depot node.

(4b) Remove edges and covered nodes (e.g., neighbors) and their edges from graph.

It is appreciated that both example solutions can assign depot nodes based on an edge rank (e.g., number of edges connected to the subject node), for example at pseudo code process (4a) or (3b). In some cases, two or more nodes may have the same highest edge rank. In those cases, ties can be resolved in any suitable manner For example, in some embodiments ties can be resolved randomly. In other embodiments, ties can be resolved based on other metrics such as, for example, a distance from a graph boundary (e.g., nearest node to—or farthest node from—a graph boundary is the winner/loser), distance from another depot node already determined or processed (e.g., nearest node to—or farthest node from—a another depot node is the winner/loser), or another suitable technique.

As noted previously, the actual solution that identifies depot nodes and, by proxy, the associated depot locations can vary based on the type of sparing procedure 106 selected, two examples of which (e.g., a greedy random solution and a greedy solution) are detailed above. Selection of the particular type of sparing procedure 106 can be based on data 402, several examples of which are described in connection with FIG. 5.

Referring now to FIG. 5, illustration 500 is depicted. Illustration 500 depicts various examples of data 402 that can be relied upon to select a particular type of sparing procedure 106 in accordance with certain embodiments of this disclosure. For example, data 402 can be indicative of equipment density data 502. Equipment density data 502 can be representative of a number of devices of device type 112 that are in-use within a defined geographical space comprising group of locations 110. As an illustrative example, the greedy random solution type of sparing procedure 106 can be selected if equipment density data 502 is below a defined threshold, whereas the greedy solution type of sparing procedure 106 can be selected if equipment density data 502 is not below the defined threshold.

As another example, data 402 can be indicative of failure rate data 504 representative of a failure rate of devices having device type 112. Hence, the type of sparing procedure 106 can be selected based on failure rate data 504. Additionally or alternatively, data 402 can be indicative of repair time data 506 representative of a time determined to facilitate removing the device and installing the spare device having device type 112. Replacement time 116 might be used as well in addition to or in lieu of the repair time.

As still another example, data 402 can be indicative of a size 508 of supply distance 120. For instance, when supply distance 120 is determined to be below a defined threshold, a first type of sparing procedure 106 can be selected. Otherwise, a second type of sparing procedure 106 can be selected instead. Data 402 can further be indicative of constraint 302. As one example, data 510 indicating the number of spare devices of device type 112 can be used in some embodiments to select the type of sparing procedure 106. These examples are intended to be non-limiting and other suitable data can be used to select the type of sparing procedure 106 to be used to identify depot nodes.

It is noted that being able to generate optimal (e.g., within a factor of optimal) spare equipment allocation at scale of the network complexity of large service providers can allow network planners to better utilize network resources. In solid-state domains, where equipment failure rates are much lower than traditional (e.g., commodity-based) equipment stocking techniques support, the disclosed techniques can produce superior sparing plans. At such low failure rates, the risk of multiple simultaneous failures can be ignored and need not be considered. While improving resource utilization has overt cost benefits, improving network resource utilization can also improve customer experiences and satisfaction.

### Example Methods

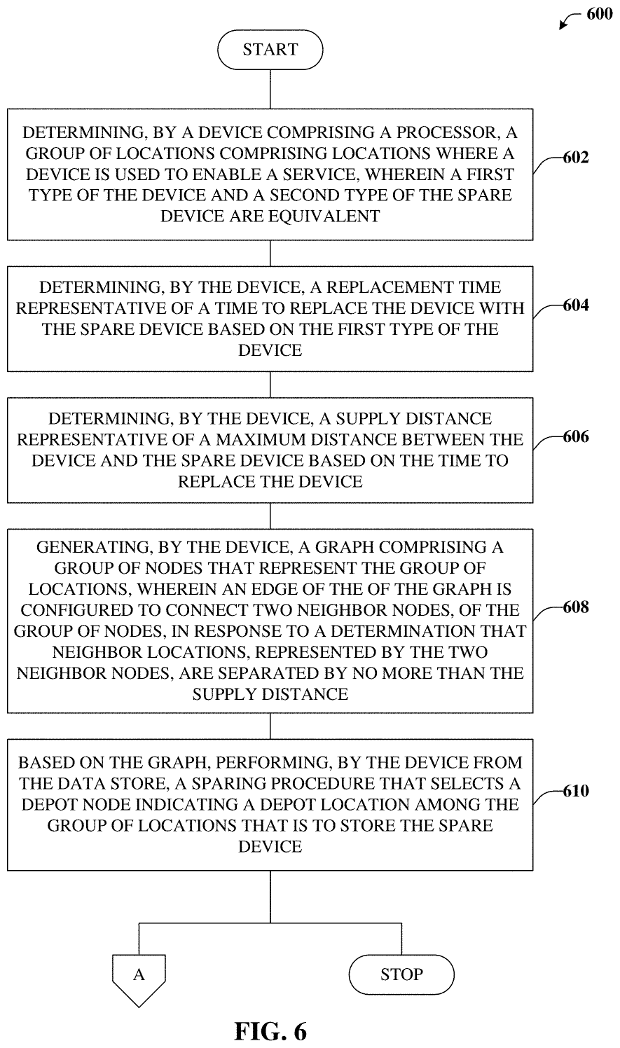

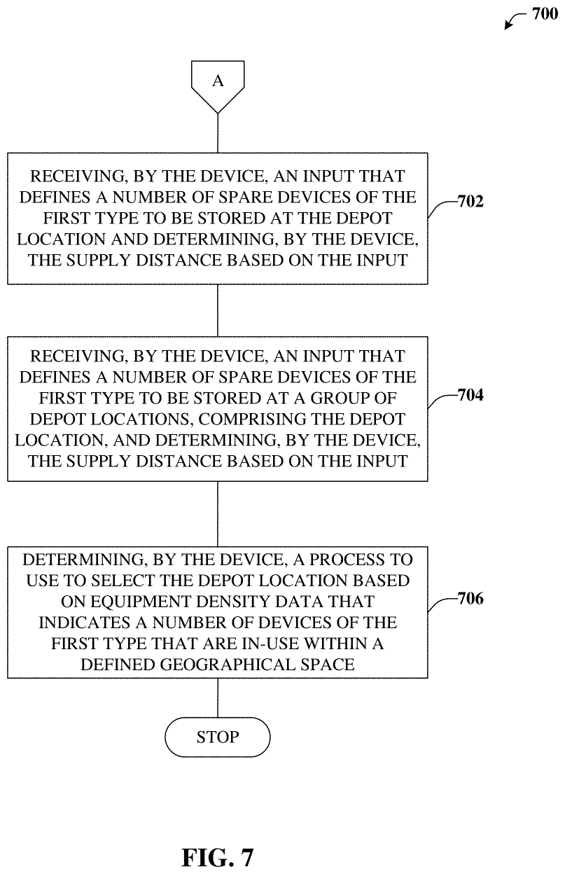

FIGS. 6 and 7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Turning now to FIG. 6, exemplary method 600 is depicted. Method 600 can perform a sparing procedure that can identify an allocation applicable to spare equipment comprising a spare device in accordance with certain embodiments of this disclosure. For example, at reference numeral 602, a device comprising a processor can determine a group of locations. The group of locations can comprise locations where a device is in-use to provide a service. In some embodiments, the group of locations can further include warehouse locations suitable for storage of the spare device. It is appreciated that a first type of the device and a second type of the spare device are equivalent. In other words, the spare device is intended to adequately replace the device in the event of a fault or failure of the device.

At reference numeral 604, the device can determine a replacement time representative of a time allowed to replace the device with the spare device. The replacement time can be a function of or based on the first type of the device. In some embodiments, the replacement time can be further based on contractual agreements, regulatory requirements, or the like that cap or constrain a total downtime permitted.

At reference numeral 606, the device can determine a supply distance representative of a maximum distance between the device and the spare device. The supply distance can be a function of or based on the replacement time determined at reference numeral 604. By way of example, neighbor locations can be determined when two locations are within the supply distance of one another, but otherwise are not considered neighbor locations.

At reference numeral 608, the device can generate a graph. This graph can comprise a group of nodes that represent the group of locations. The graph can be configured to provide one or more edges. An edge of the of the graph can connect two neighbor nodes, of the group of nodes, in response to a determination that neighbor locations, represented by the two neighbor nodes, are separated by no more than the supply distance. Edges can be populated during the generation of the graph or be populated separately by a sparing procedure that is detailed below.

At reference numeral 610, the device can perform the sparing procedure. The graph generated at reference numeral 608 can be used as input to the sparing procedure. The sparing procedure can select a depot node indicating a depot location from among the group of locations that is to store the spare device. Method 600 can stop or proceed to insert A, which is further detailed in connection with FIG. 7.

With reference now to FIG. 7, exemplary method 700 is illustrated. Method 700 can provide for additional elements or aspects in connection with the sparing procedure that can identify an allocation applicable to spare equipment comprising a spare device in accordance with certain embodiments of this disclosure. For example, at reference numeral 702, the device can receive an input that defines a number of spare devices of the first type to be stored at the depot location and determining, by the device, the supply distance based on the input. Said differently, the determination of the supply distance detailed in connection with reference numeral 606 of FIG. 6 can be further based on a constraint such as a constraint that limits the number of spare devices per depot location.

At reference numeral 704, the device can receive an input that defines a number of spare devices of the first type to be stored at a group of depot locations, comprising the depot location, and determining, by the device, the supply distance based on the input. In this case the constraint can limit the (total) number of spare devices that are to ‘cover’ the group of locations

### Example Operating Environments

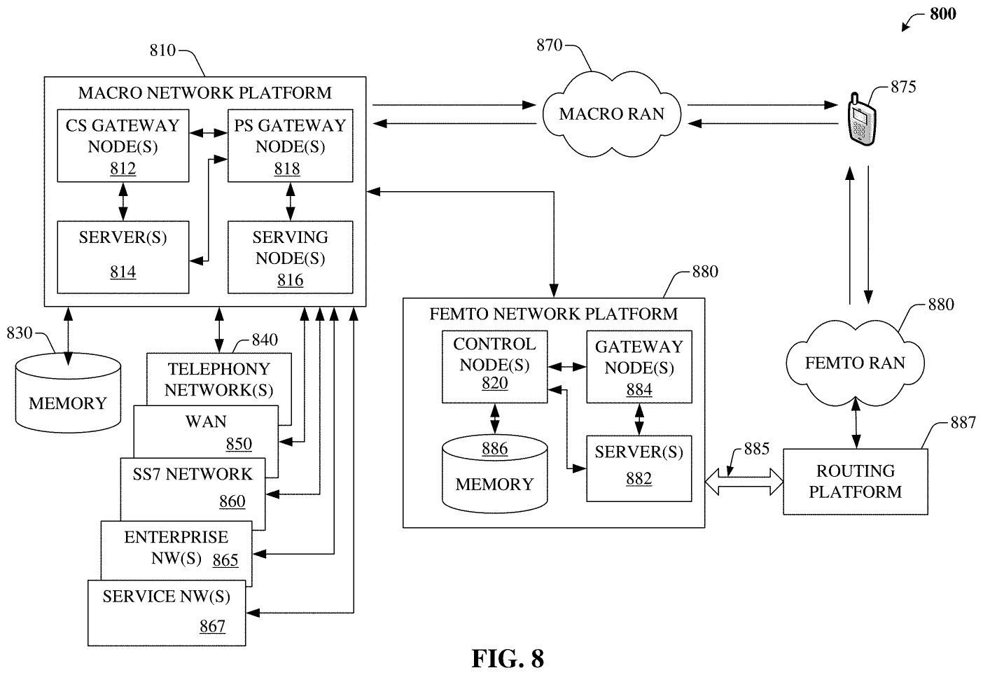

To provide further context for various aspects of the subject specification, FIG. 8 illustrates an example wireless communication environment 800, with associated components that can enable operation of a femtocell enterprise network in accordance with aspects described herein. Wireless communication environment 800 comprises two wireless network platforms: (i) A macro network platform 810 that serves, or facilitates communication with, user equipment 875 via a macro radio access network (RAN) 870. It should be appreciated that in cellular wireless technologies (e.g., 4G, 3GPP UMTS, HSPA, 3GPP LTE, 3GPP UMB, 5G), macro network platform 810 is embodied in a Core Network. (ii) A femto network platform 880, which can provide communication with UE 875 through a femto RAN 890, linked to the femto network platform 880 through a routing platform 887 via backhaul pipe(s) 885. It should be appreciated that femto network platform 880 typically offloads UE 875 from macro network, once UE 875 attaches (e.g., through macro-to-femto handover, or via a scan of channel resources in idle mode) to femto RAN.

It is noted that RAN comprises base station(s), or access point(s), and its associated electronic circuitry and deployment site(s), in addition to a wireless radio link operated in accordance with the base station(s). Accordingly, macro RAN1370 can comprise various coverage cells, while femto RAN 890 can comprise multiple femto access points or multiple metro cell access points. As mentioned above, it is to be appreciated that deployment density in femto RAN 890 can be substantially higher than in macro RAN 870.

Generally, both macro and femto network platforms 810 and 880 comprise components, e.g., nodes, gateways, interfaces, servers, or platforms, that facilitate both packet-switched (PS) (e.g., internet protocol (IP), Ethernet, frame relay, asynchronous transfer mode (ATM)) and circuit-switched (CS) traffic (e.g., voice and data) and control generation for networked wireless communication. In an aspect of the subject innovation, macro network platform 810 comprises CS gateway node(s) 812 which can interface CS traffic received from legacy networks like telephony network(s) 840 (e.g., public switched telephone network (PSTN), or public land mobile network (PLMN)) or a SS7 network 860. Circuit switched gateway 812 can authorize and authenticate traffic (e.g., voice) arising from such networks. Additionally, CS gateway 812 can access mobility, or roaming, data generated through SS7 network 860; for instance, mobility data stored in a VLR, which can reside in memory 830. Moreover, CS gateway node(s) 812 interfaces CS-based traffic and signaling and gateway node(s) 818. As an example, in a 3GPP UMTS network, gateway node(s) 818 can be embodied in gateway GPRS support node(s) (GGSN).

In addition to receiving and processing CS-switched traffic and signaling, gateway node(s) 818 can authorize and authenticate PS-based data sessions with served (e.g., through macro RAN) wireless devices. Data sessions can comprise traffic exchange with networks external to the macro network platform 810, like wide area network(s) (WANs) 850; it should be appreciated that local area network(s) (LANs) can also be interfaced with macro network platform 810 through gateway node(s) 818. Gateway node(s) 818 generates packet data contexts when a data session is established. To that end, in an aspect, gateway node(s) 818 can comprise a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can comprise multiple flows that can be generated through server(s) 814. It is to be noted that in 3GPP UMTS network(s), gateway node(s)1318 (e.g., GGSN) and tunnel interface (e.g., TTG) comprise a packet data gateway (PDG).

Macro network platform 810 also comprises serving node(s) 816 that convey the various packetized flows of information or data streams, received through gateway node(s) 818. As an example, in a 3GPP UMTS network, serving node(s) can be embodied in serving GPRS support node(s) (SGSN).

As indicated above, server(s) 814 in macro network platform 810 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can comprise add-on features to standard services provided by macro network platform 810. Data streams can be conveyed to gateway node(s) 818 for authorization/authentication and initiation of a data session, and to serving node(s) 816 for communication thereafter. Server(s) 814 can also effect security (e.g., implement one or more firewalls) of macro network platform 810 to ensure network's operation and data integrity in addition to authorization and authentication procedures that CS gateway node(s) 812 and gateway node(s) 818 can enact. Moreover, server(s) 814 can provision services from external network(s), e.g., WAN 850, or Global Positioning System (GPS) network(s) (not shown). It is to be noted that server(s) 814 can comprise one or more processor configured to confer at least in part the functionality of macro network platform 810. To that end, the one or more processor can execute code instructions stored in memory 830, for example.

In example wireless environment 800, memory 830 stores information related to operation of macro network platform 810. Information can comprise business data associated with subscribers; market plans and strategies, e.g., promotional campaigns, business partnerships; operational data for mobile devices served through macro network platform; service and privacy policies; end-user service logs for law enforcement; and so forth. Memory 830 can also store information from at least one of telephony network(s) 840, WAN(s) 850, or SS7 network 860, enterprise NW(s) 865, or service NW(s) 867.

Femto gateway node(s) 884 have substantially the same functionality as PS gateway node(s) 818. Additionally, femto gateway node(s) 884 can also comprise substantially all functionality of serving node(s) 816. In an aspect, femto gateway node(s) 884 facilitates handover resolution, e.g., assessment and execution. Further, control node(s) 820 can receive handover requests and relay them to a handover component (not shown) via gateway node(s) 884. According to an aspect, control node(s) 820 can support RNC capabilities.

Server(s) 882 have substantially the same functionality as described in connection with server(s) 814. In an aspect, server(s) 882 can execute multiple application(s) that provide service (e.g., voice and data) to wireless devices served through femto RAN 890. Server(s) 882 can also provide security features to femto network platform. In addition, server(s) 882 can manage (e.g., schedule, queue, format . . . ) substantially all packetized flows (e.g., IP-based) it generates in addition to data received from macro network platform 810. It is to be noted that server(s) 882 can comprise one or more processor configured to confer at least in part the functionality of macro network platform 810. To that end, the one or more processor can execute code instructions stored in memory 886, for example.

Memory 886 can comprise information relevant to operation of the various components of femto network platform 880. For example, operational information that can be stored in memory 886 can comprise, but is not limited to, subscriber information; contracted services; maintenance and service records; femto cell configuration (e.g., devices served through femto RAN 890; access control lists, or white lists); service policies and specifications; privacy policies; add-on features; and so forth.

It is noted that femto network platform 880 and macro network platform 810 can be functionally connected through one or more reference link(s) or reference interface(s). In addition, femto network platform 880 can be functionally coupled directly (not illustrated) to one or more of external network(s) 840, 850, 860, 865 or 867. Reference link(s) or interface(s) can functionally link at least one of gateway node(s) 884 or server(s) 886 to the one or more external networks 840, 850, 860, 865 or 867.

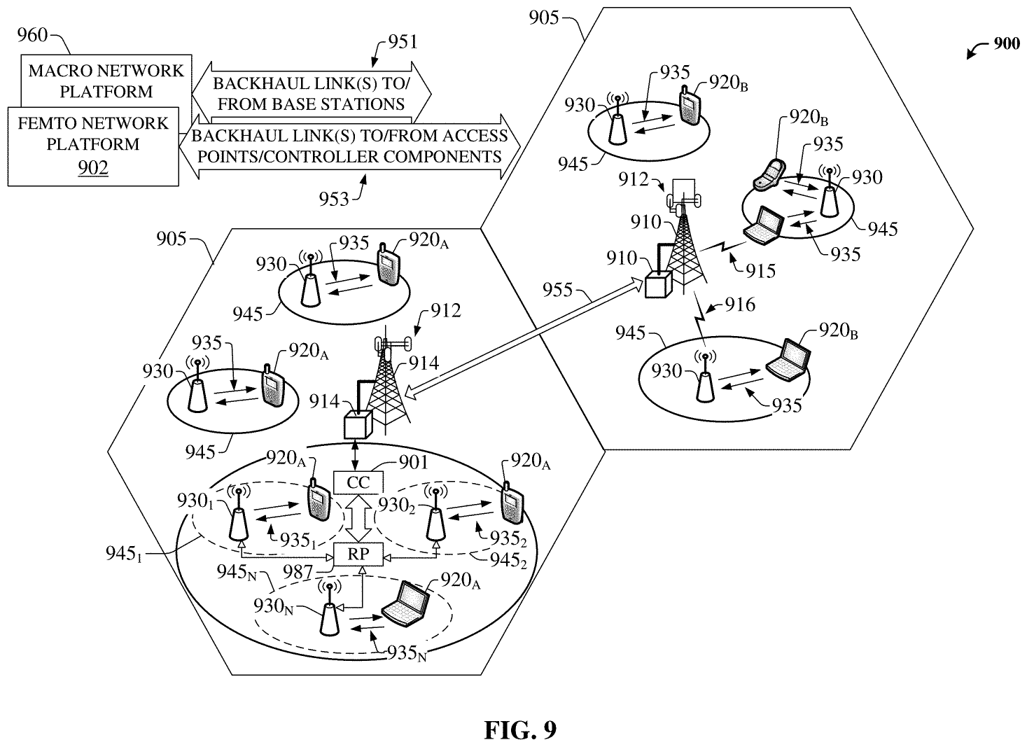

FIG. 9 illustrates a wireless environment that comprises macro cells and femtocells for wireless coverage in accordance with aspects described herein. In wireless environment 905, two areas represent “macro” cell coverage; each macro cell is served by a base station 910. It can be appreciated that macro cell coverage area 905 and base station 910 can comprise functionality, as more fully described herein, for example, with regard to system 900. Macro coverage is generally intended to serve mobile wireless devices, like UE 920_{A}, 920_{B}, in outdoors locations. An over-the-air (OTA) wireless link 935 provides such coverage, the wireless link 935 comprises a downlink (DL) and an uplink (UL), and utilizes a predetermined band, licensed or unlicensed, of the radio frequency (RF) spectrum. As an example, UE 920A, 920B can be a 3GPP Universal Mobile Telecommunication System (UMTS) mobile phone. It is noted that a set of base stations, its associated electronics, circuitry or components, base stations control component(s), and wireless links operated in accordance to respective base stations in the set of base stations form a radio access network (RAN). In addition, base station 910 communicates via backhaul link(s) 951 with a macro network platform 960, which in cellular wireless technologies (e.g., 3rd Generation Partnership Project (3GPP) Universal Mobile Telecommunication System (UMTS), Global System for Mobile Communication (GSM)) represents a core network.

In an aspect, macro network platform 960 controls a set of base stations 910 that serve either respective cells or a number of sectors within such cells. Base station 910 comprises radio equipment 914 for operation in one or more radio technologies, and a set of antennas 912 (e.g., smart antennas, microwave antennas, satellite dish(es) . . . ) that can serve one or more sectors within a macro cell 905. It is noted that a set of radio network control node(s), which can be a part of macro network platform 960; a set of base stations (e.g., Node B 910) that serve a set of macro cells 905; electronics, circuitry or components associated with the base stations in the set of base stations; a set of respective OTA wireless links (e.g., links 915 or 916) operated in accordance to a radio technology through the base stations; and backhaul link(s) 955 and 951 form a macro radio access network (RAN). Macro network platform 960 also communicates with other base stations (not shown) that serve other cells (not shown). Backhaul link(s) 951 or 953 can comprise a wired backbone link (e.g., optical fiber backbone, twisted-pair line, T1/E1 phone line, a digital subscriber line (DSL) either synchronous or asynchronous, an asymmetric ADSL, or a coaxial cable . . . ) or a wireless (e.g., LoS or non-LoS) backbone link. Backhaul pipe(s) 955 link disparate base stations 910. According to an aspect, backhaul link 953 can connect multiple femto access points 930 and/or controller components (CC) 901 to the femto network platform 902. In one example, multiple femto APs can be connected to a routing platform (RP) 987, which in turn can be connect to a controller component (CC) 901. Typically, the information from UEs 920_{A} can be routed by the RP 987, for example, internally, to another UE 920_{A} connected to a disparate femto AP connected to the RP 987, or, externally, to the femto network platform 902 via the CC 901, as discussed in detail supra.

In wireless environment 905, within one or more macro cell(s) 905, a set of femtocells 945 served by respective femto access points (APs) 930 can be deployed. It can be appreciated that, aspects of the subject innovation can be geared to femtocell deployments with substantive femto AP density, e.g., 9⁴-10⁷ femto APs 930 per base station 910. According to an aspect, a set of femto access points 930₁-930_{N}, with N a natural number, can be functionally connected to a routing platform 987, which can be functionally coupled to a controller component 901. The controller component 901 can be operationally linked to the femto network platform 902 by employing backhaul link(s) 953. Accordingly, UE 920A connected to femto APs 930₁-930_{N} can communicate internally within the femto enterprise via the routing platform (RP) 987 and/or can also communicate with the femto network platform 902 via the RP 987, controller component 901 and the backhaul link(s) 953. It can be appreciated that although only one femto enterprise is depicted in FIG. 9, multiple femto enterprise networks can be deployed within a macro cell 905.

It is noted that while various aspects, features, or advantages described herein have been illustrated through femto access point(s) and associated femto coverage, such aspects and features also can be exploited for home access point(s) (HAPs) that provide wireless coverage through substantially any, or any, disparate telecommunication technologies, such as for example Wi-Fi (wireless fidelity) or picocell telecommunication. Additionally, aspects, features, or advantages of the subject innovation can be exploited in substantially any wireless telecommunication, or radio, technology; for example, Wi-Fi, Worldwide Interoperability for Microwave Access (WiMAX), Enhanced General Packet Radio Service (Enhanced GPRS), 3GPP LTE, 3GPP2 UMB, 3GPP UMTS, HSPA, HSDPA, HSUPA, or LTE Advanced. Moreover, substantially all aspects of the subject innovation can comprise legacy telecommunication technologies.

With respect to FIG. 9, in example embodiment 900, base station AP 910 can receive and transmit signal(s) (e.g., traffic and control signals) from and to wireless devices, access terminals, wireless ports and routers, etc., through a set of antennas 912₁-912_{N}. It should be appreciated that while antennas 912₁-912_{N} are a part of communication platform 925, which comprises electronic components and associated circuitry that provides for processing and manipulating of received signal(s) (e.g., a packet flow) and signal(s) (e.g., a broadcast control channel) to be transmitted. In an aspect, communication platform 925 comprises a transmitter/receiver (e.g., a transceiver) 966 that can convert signal(s) from analog format to digital format upon reception, and from digital format to analog format upon transmission. In addition, receiver/transmitter 966 can divide a single data stream into multiple, parallel data streams, or perform the reciprocal operation. Coupled to transceiver 966 is a multiplexer/demultiplexer 967 that facilitates manipulation of signal in time and frequency space. Electronic component 967 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 967 can scramble and spread information (e.g., codes) according to substantially any code known in the art; e.g., Hadamard-Walsh codes, Baker codes, Kasami codes, polyphase codes, and so on. A modulator/demodulator 968 is also a part of operational group 925, and can modulate information according to multiple modulation techniques, such as frequency modulation, amplitude modulation (e.g., M-ary quadrature amplitude modulation (QAM), with M a positive integer), phase-shift keying (PSK), and the like.

Referring now to FIG. 10, there is illustrated a block diagram of an exemplary computer system operable to execute the disclosed architecture. In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

What has been described above comprises examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from by a computing device.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

What is claimed is:

1. A device, comprising:
a processor; and
a memory that stores executable instructions that, when executed by the processor, facilitate performance of operations for a sparing procedure that identifies an allocation applicable to spare equipment comprising a spare device, the operations comprising:
determine a group of locations comprising locations where a device is operable to provide a service, wherein a type of the device and a type of the spare device are equivalent;
as a function of the type of the device, determining a replacement time representative of a time allotted to replace the device with the spare device;
as a function of the replacement time, determining a supply distance representative of a maximum permitted distance between the device and the spare device;
generating a graph comprising a group of nodes that represent the group of locations, wherein an edge of the of the graph is configured to connect two neighbor nodes, of the group of nodes, in response to a determination that neighbor locations, represented by the two neighbor nodes, are separated by no more than the supply distance; and
using the graph as input, performing the sparing procedure that selects a depot node, of the group of nodes, indicating a depot location among the group of locations that is to store the spare device.

2. The device of claim 1, wherein the group of locations further comprises a warehouse location suitable to store the spare device.

3. The device of claim 1, wherein determining the supply distance is further based on a constraint that limits a number of spare devices comprised by the spare equipment.

4. The device of claim 1, wherein determining the supply distance is further based on a constraint that limits a number of spare devices per depot location.

5. The device of claim 4, wherein the number of spare devices per depot location is limited to one.

6. The device of claim 1, wherein the sparing procedure determines the depot node in response to application of a process of a group of processes comprising: a greedy random process and a greedy process.

7. The device of claim 6, wherein the operations further comprise selecting the greedy random process as the process to apply in response to equipment density data being determined to be below a defined threshold and selecting the greedy process as the process to apply in response to the equipment density data being determined to be at least the defined threshold, and wherein the equipment density data represents a number of devices of the type of the device that are in-use within a defined geographical space comprising the group of locations.

8. The device of claim 6, wherein the operations further comprise selecting the process to apply based on failure rate data indicative of a rate of failure of devices of the type of the device.

9. The device of claim 6, wherein the operations further comprise selecting the process to apply based on a size of the supply distance.

10. The device of claim 6, wherein the operations further comprise selecting the process to apply based on a number of spare devices comprised by the spare equipment.

11. The device of claim 6, wherein the greedy random process facilitates performance of operations comprising:
randomly selecting a random node from the group of nodes;
identifying neighbor nodes indicative of neighbors of the random node;
selecting, from among the random node and the neighbor nodes, a node as the depot node in response to the node having a highest number of edges; and
removing the random node and the neighbor nodes from the group of nodes.

12. The device of claim 6, wherein the greedy random process facilitates performance of operations comprising:
identifying boundary nodes indicative of nodes within a defined number of hops from a boundary of the graph;
selecting, from among the boundary nodes, a node as the depot node in response to the node having a highest number of edges, wherein an edge of the edges represents a neighbor relationship that is determined as a function of the supply distance; and
removing the node and nodes connected to the node by any edge of the edges from the group of nodes.

13. A non-transitory machine-readable medium, comprising executable instructions that, when executed by a processor, facilitate performance of operations, comprising, comprising:
determine a group of locations comprising locations where a device is in-use to provide a service, wherein a first type of the device and a second type of the spare device are equivalent;
based on the first type of the device, determining a replacement time representative of a time allowed to replace the device with the spare device;
based on the time to replace the device, determining a supply distance representative of a maximum distance between the device and the spare device;
generating a graph comprising a group of nodes that represent the group of locations, wherein an edge of the of the graph connects two neighbor nodes, of the group of nodes, in response to a determination that neighbor locations, represented by the two neighbor nodes, are separated by no more than the supply distance; and
based on the graph, performing a sparing procedure that selects a depot node indicating a depot location among the group of locations that is to store the spare device.

14. The non-transitory machine-readable medium of claim 13, wherein the sparing procedure determines the depot node in response to application of a solution of a group of solutions comprising: a greedy random solution and a greedy solution.

15. The non-transitory machine-readable medium of claim 14, wherein the operations further comprise choosing the solution to apply based on equipment density data representative of a density of devices of the first type that are in-use within a defined geographical space.

16. The non-transitory machine-readable medium of claim 14, wherein the operations further comprise choosing the solution to apply based on the replacement time.

17. A method, comprising:
determining, by a device comprising a processor, a group of locations comprising locations where a device is used to enable a service, wherein a first type of the device and a second type of the spare device are equivalent;
determining, by the device, a replacement time representative of a time allotted to replace the device with the spare device based on the first type of the device;
determining, by the device, a supply distance representative of a maximum distance between the device and the spare device based on the time to replace the device;
generating, by the device, a graph comprising a group of nodes that represent the group of locations, wherein an edge of the of the graph is configured to connect two neighbor nodes, of the group of nodes, in response to a determination that neighbor locations, represented by the two neighbor nodes, are separated by no more than the supply distance; and
based on the graph, performing, by the device from the data store, a sparing procedure that selects a depot node indicating a depot location among the group of locations that is to store the spare device.

18. The method of claim 17, further comprising receiving, by the device, an input that defines a number of spare devices of the first type to be stored at the depot location and determining, by the device, the supply distance based on the input.

19. The method of claim 17, further comprising receiving, by the device, an input that defines a number of spare devices of the first type to be stored at a group of depot locations, comprising the depot location, and determining, by the device, the supply distance based on the input.

20. The method of claim 19, further comprising, determining, by the device, a process to use to select the depot location based on equipment density data that indicates a number of devices of the first type that are in-use within a defined geographical space.
